(19) United States
(12) Patent Application Publication
(10) Pub. No.: US 2019/0124392 A1
(43) Pub. Date: Apr. 25, 2019

(54) DETERMINING QUALITY ISSUES IN ADVANCE OF A MEDIA BROADCAST

(71) Applicant: International Business Machines Corporation, Armonk, NY (US)

(72) Inventors: Al Chakra, Apex, NC (US); Jonathan Dunne, Dungarvan (IE); Paul B. French, Cork (IE); James P. Galvin, JR., Georgetown, KY (US)

(21) Appl. No.: 15/792,256

(22) Filed: Oct. 24, 2017

(51) Int. Cl. H04N 21/431; H04L 29/06; H04N 21/643; H04N 21/442

(52) U.S. Cl. CPC H04N 21/4314; H04L 65/80; H04L 65/4076; H04N 21/4821; H04L 65/601; H04N 21/44209; H04N 21/64322

(57) ABSTRACT

A method includes determining, by a controller of a content provider, at least one broadcast that is transmitted to at least one end user. The method also includes determining a predicted broadcast quality of the at least one broadcast. The method also includes transmitting an indication of the predicted broadcast quality to the at least one end user.

### BACKGROUND

One or more embodiments relate in general to determining quality issues in advance of a media broadcast. More specifically, one or more embodiments relate to determining quality issues in advance of a media broadcast and informing an end user of the quality issues.

Internet Protocol television (IPTV) generally relates to the distribution of television programs using data transmissions that are relayed using internet protocol communication, as opposed to using traditional terrestrial, satellite, and/or cable signals. With IPTV, television programs 1 be continuously streamed to viewers. Video conferencing can also be conducted using internet protocol communication. Video conferencing generally refers to technologies that enable receiving and transmitting of audio/video signals by different participants of the conference.

### SUMMARY

According to one or more embodiments, a method includes determining, by a controller of a content provider, at least one broadcast that is transmitted to at least one end user. The method also includes determining a predicted broadcast quality of the at least one broadcast. The method also includes transmitting an indication of the predicted broadcast quality to the at least one end user.

According to one or more embodiments, a computer system includes a memory. The computer system includes a processor system communicatively coupled to the memory. The processor system is configured to perform a method including determining at least one broadcast that is transmitted to at least one end user. The method also includes determining a predicted broadcast quality of the at least one of 23 broadcast. The method also includes transmitting an indication of the predicted broadcast quality to the at least one end user.

According to one or more embodiments, a computer program product includes a computer-readable storage medium having program instructions embodied therewith. The computer-readable storage medium is not a transitory signal per se, the program instructions readable by a processor system to cause the processor system to perform a method including determining, by a controller of a content provider, at least one broadcast that is transmitted to at least one end user. The method includes determining a predicted broadcast quality of the at least one broadcast. The method includes transmitting an indication of the predicted broadcast quality to the at least one end user.

### BRIEF DESCRIPTION OF THE DRAWINGS

The subject matter of one or more embodiments is particularly pointed out and distinctly defined in the claims at the conclusion of the specification. The foregoing and other features and advantages are apparent from the following detailed description taken in conjunction with the accompanying drawings in which:

FIG. 1 illustrates an internet protocol television system that monitors a broadcast quality, in accordance with one or more embodiments;

FIG. 2 illustrates informing an end user of a broadcast quality, in accordance with one or more embodiments;

FIG. 3 illustrates an internet protocol television system that receives feedback information from one or more end users, in accordance with one or more embodiments;

FIG. 4 illustrates determining profile information for a plurality of end users, in accordance with one or more embodiments;

FIG. 5 depicts a flowchart of a method, in accordance with one or more embodiments;

FIG. 6 depicts a high-level block diagram of a computer system, which can be used to implement one or more embodiments; and

FIG. 7 depicts a computer program product, in accordance with one or more embodiments.

### DETAILED DESCRIPTION

In accordance with one or more embodiments, methods and computer program products for determining quality issues in advance of a media broadcast are provided. With the current approaches, if an end user is watching a broadcast via a broadcast system, the system does not provide any advance warning to the end user regarding undesirable quality issues that are likely to be encountered during the course of the broadcast. As such, end users who use the current approaches are often frustrated when they encounter undesirable quality issues without any advance warning. In contrast to the current approaches, one or more embodiments determine quality issues for a media broadcast before these issues are encountered by the end user, and thus the end user can be informed of the quality issues in advance. Therefore, one or more embodiments can help end users to have more realistic expectations of broadcast quality, and these end users can prepare themselves to view the media broadcast on an alternative channel, if necessary. Various embodiments are described herein with reference to the related drawings. Alternative embodiments can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Additionally, although this disclosure includes a detailed description of a computing device configuration, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

For the sake of brevity, conventional techniques related to computer processing systems and computing models may or may not be described in detail herein. Moreover, it is understood that the various tasks and process steps described herein can be incorporated into a more comprehensive procedure, process or system having additional steps or functionality not described in detail herein.

Information and media technologies have grown dramatically in the past decade. With the growth of these technologies, convergence services such as Digital Multimedia Broadcasting (DMB) and Internet Protocol Television (IPTV) have also experienced significant development. Additionally, high-definition television technologies were born as a result of an increased use/prevalence of digital cables for transmitting data.

The above-described changes have impacted the traditional television landscape. Currently, new delivery techniques are threatening the position of traditional media services. For example, IPTV is expected to introduce additional competition in the field of television broadcasting. Additionally, electronic-learning broadcasts have impacted the field of online learning and education.

IPTV is generally considered to be technology where television signals are distributed over an IP-based data network. Because end users can have more control over the television signals that are distributed to them, such distribution of television signals provides a more customized and interactive user experience.

IPTV technology acquires content signals that are to be transmitted to end users (where the content signals can be demodulated and decrypted, if necessary). The technology can then digitally re-encode the content signals for IP transport, possibly by performing additional compression and/or encryption. The content signals are then transmitted via IP transport to the end users. IPTV can be implemented as an end-to-end system or as a proprietary TV (and semi-closed) system. Implementing IPTV as a proprietary TV system corresponds to providing a service that is similar to a cable service.

There is an increasing demand for media content to be displayed in a manner that is smooth, high-resolution, and lag-free. Consequently, IPTV distribution networks are generally designed in a manner that meets these demands. In other words, the IPTV distribution networks are generally configured to deliver content at an adequate bandwidth while meeting certain broadcast quality requirements. Broadcast quality can be measured by Quality of Experience (QoE) and/or Quality of Service (QoS) measurements, for example.

In addition to television content, electronic learning media can also be distributed with an IPTV distribution network. In order for electronic learning (eLearning) media to be properly distributed, the media needs to be displayed in a manner that is smooth, high-resolution, and lag-free. eLearning media needs to be provided as a smooth and high-quality video experience so that video-captured chalkboard equations and video-captured diagrams are not distorted by poor broadcast quality.

If an end user is watching a current broadcast, and the current broadcast is predicted to have undesirable quality issues, then the end user should be informed of these issues. Service providers can predict a broadcast quality of the current broadcast based on determining an available bandwidth for the broadcast, a programming type of the broadcast, and/or the types of viewers that view the broadcast, for example. Upon being informed of the predicted issues, the informed end user can then decide whether to continue watching the current broadcast or to choose another broadcast (i.e., another channel) that is less problematic. Currently, if an end user is watching a broadcast via a broadcast system, the system does not provide any advance warning to the end user regarding undesirable quality issues that are likely to be encountered during the course of the broadcast.

For example, if an end user is watching live sports broadcast on a first channel (such as SportsHD1 channel), and if the live sports broadcast is predicted to suffer from a temporal broadcast problem, then the end user should be informed of the predicted temporal broadcast problem. As described above, service providers can predict a possible predicted temporal broadcast problem for a broadcast based on determining an available bandwidth for the broadcast, a programming type of the broadcast, and/or the types of viewers that view the broadcast, for example. The informed end user can then decide whether to continue watching the first channel (SportsHD1) or to view the broadcast on another channel with no such predicted temporal issues. For example, this other channel can be a non-high-definition channel source such as channel Sports2. In contrast to the current approaches, one or more embodiments determine quality issues for a media broadcast before these issues are encountered by the end user. One or more embodiments can inform the end user via one or more displayed visual cues of an electronic program guide, for example.

Similarly, if an electronic learning lecture is predicted to suffer from poor quality, the end user/student should also be informed of the predicted problem. The end user/student can then decide whether to switch to similar course content that is offered by a different provider/channel. The end user/student should also be given the opportunity to provide feedback to the content provider.

In view of the issues described above, one or more embodiments are directed to a service provider that is configured to monitor a broadcast quality of broadcasts that are broadcasted to the end user. The broadcast quality can be monitored on a per channel basis. One or more embodiments can also inform end users of the predicted quality of the broadcasts. Also, one or more embodiment can allow the end user to provide feedback (in the form of a rating, for example) regarding whether a given program or lecture was successfully broadcasted.

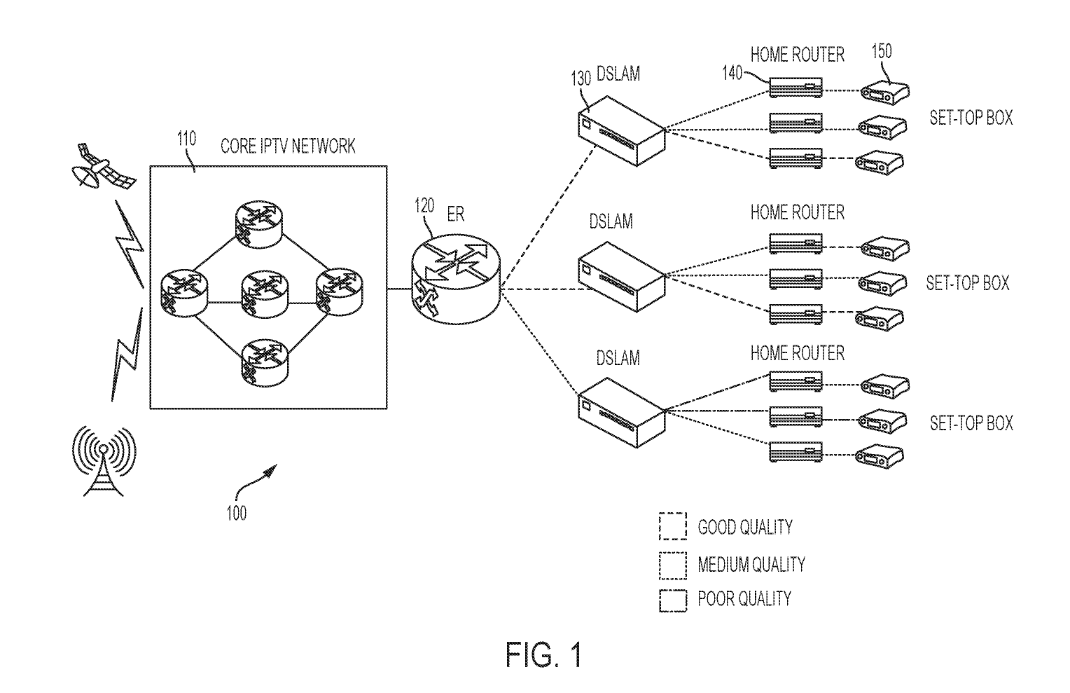

FIG. 1 illustrates an internet protocol television system 100 that monitors a broadcast quality, in accordance with one or more embodiments. The internet protocol television system 100 can be implemented by a service provider, for example. The internet protocol television system 100 can include a core IPTV network 110, an edge router 120, one or more digital subscriber line access multiplexers (DSLAM) 130, one or more home routers 140, and/or one or more set-top boxes 150. The set-top boxes 150 can be located at the locations of the end users who are accessing the content. The end user can also provide feedback regarding the broadcasting.

As described above, with one or more embodiments, a service provider can monitor the quality of broadcasts. Referring to FIG. 1, each of the broadcasts between edge router 120 and each DSLAM can be of a different broadcast quality. Each of the broadcasts between each DSLAM and each home router can be of a different broadcast quality. Each of the broadcasts between each home router and each set-top box can be of a different broadcast quality.

An IPTV service provider can be configured to determine predicted broadcast quality measurements for the IPTV service provider's subsystems. Based on the predicted broadcast quality measurements, the service provider is configured to infer which channels/broadcasts are likely to be transmitted successfully. In other words, the service provider is able to determine information regarding which channels/broadcasts are likely to be transmitted successfully. Therefore, one or more embodiments can measure a predicted broadcast quality based on the likelihood that the broadcast will be transmitted without interruption. For example, a measurement of 90% can correspond to a 90% likelihood that the broadcast will be transmitted without interruption. Other embodiments can use other numerical measurements to measure the predicted broadcast quality.

One or more embodiments can be configured to transmit information (that is derived from the monitored broadcast quality) to the end user. The end user is informed of the predicted quality issues of the broadcasts. One or more embodiments provide the end user with the information regarding which channels/broadcasts are likely to suffer from transmission problems. The end user can receive the information as an objective score and/or in any other manner that will be informative to the end users.

With one or more embodiments, the end user provides feedback to the service provider via a remote or keyboard. The service provider can then perform analysis on both the determined broadcast quality metrics and the feedback metrics (provided by the end user) in order to determine a channel-hop parameter (CHP). By using the CHP, a service provider is able to determine a point in time in the broadcast that an end user is likely to switch channels. The service provider can then adjust broadcast resources in accordance to the derived CHP. For example, if an embodiment determines that an end user is likely to switch channels, then the current broadcast can be improved in an attempt to prevent the end user from switching channels.

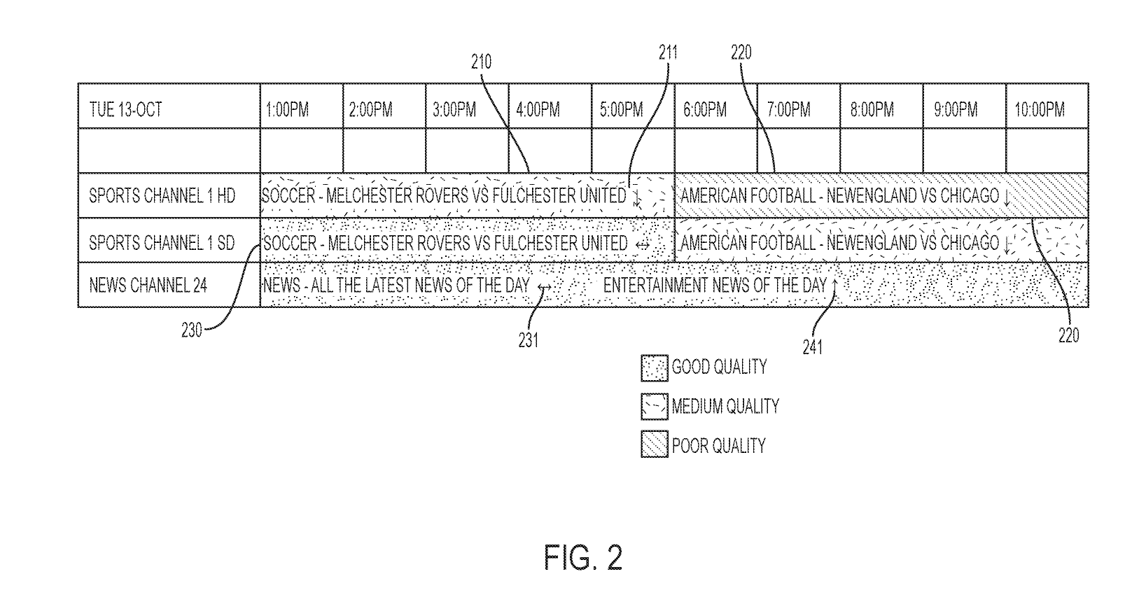

FIG. 2 illustrates informing an end user of a broadcast quality in accordance with one or more embodiments. One or more embodiments inform the end user of predicted quality issues by providing a visual cue to the end user. For example, one or more embodiments can display a visual overlay in an electronic program guide (EPG) to the end user. The quality issues can be predicted in advance by minutes or by hours, depending on how accurate the prediction needs to be. A prediction of issues that are to occur within a few minutes will likely be more accurate than a prediction of issues that are to occur within a few hours. One or more embodiments can use a threshold accuracy. One or more embodiments can perform the prediction by using an auto-regressive moving average model. The overlay and EPG will allow end users to view a predicted quality of a given broadcast. For example, one or more embodiments can use different visual patterns/colors within the EPG to inform the end users of the predicted quality of different broadcasts. For example, if a green color is assigned to a broadcast, then the green color can indicate that the broadcast quality for the broadcast is optimal and that there are no predicted undesirable issues. If a yellow color is assigned to the broadcast, then the yellow color can indicate that the broadcast quality for the broadcast is acceptable and that some small undesirable issues are likely to occur. If a red color is assigned to the broadcast, then the red color can indicate that the broadcast quality of the broadcast is expected to be poor and that major undesirable issues will likely occur.

In the example of FIG. 2, the color/pattern of program 210 (“Soccer-Melchester Rovers Vs Fulchester United” on Sports Channel 1 HD) indicates that the quality of the broadcast is of a medium transmission/broadcast quality. On the other hand, the color/pattern of program 220 (“American Football—NewEngland Vs Chicago” on Sports Channel 1 HD) indicates that the quality of the broadcast is of a poor transmission/broadcast quality. The color/pattern of program 230 (“Soccer—Melchester Rovers Vs Fulchester United” on Sports Channel 1 SD) indicates that the quality of the broadcast is of a good transmission/broadcast quality. Upon viewing the EPG of FIG. 2, the end user can be informed of the different broadcast quality across various broadcasts.

If the end user is informed that a broadcast is rated as being of high transmission quality, the end user will likely continue watching the program. Different levels of transmission quality can be defined by different thresholds of video quality, different thresholds of a peak-signal to noise ratio, different thresholds of latency, different mean opinion scores, and/or different thresholds of perceptual evaluation of video quality, for example. If the broadcast is rated as being moderate, then the end user can possibly decide to first watch the broadcast in high-definition and then later watch the broadcast in standard definition if the end user becomes unsatisfied with the high-definition broadcast quality. One or more embodiments can provide the different viewing channels/options to the end user. If the end user is informed that a broadcast quality is rated as being poor, then the end user will likely not watch the program at all.

As such, because the end user will receive a predicted broadcast quality for each broadcast, one or more embodiments can encourage the service provider to provide sufficient resource allocation to each channel in order to provide at least a moderate level of broadcasting for each channel.

With one or more embodiments, an EPG can also display trending information that is related to a broadcast. For example, the EPG can display whether the broadcast quality of a current broadcast transmission is better or worse than previously measured. The EPG can also display whether the broadcast quality is predicted to improve, stay the same, or deteriorate, for example. As described above, the quality issues can be predicted in advance by minutes or hours, depending on how accurate the prediction needs to be. Referring again to FIG. 2, a downward arrow indicator 211 can indicate that the quality of the broadcast is trending downwards from medium quality to poor quality. A sideways arrow indicator 231 indicates that the quality of the broadcast is at a steady good quality. An upwards arrow indicator 241 can indicate that the quality of the broadcast is improving.

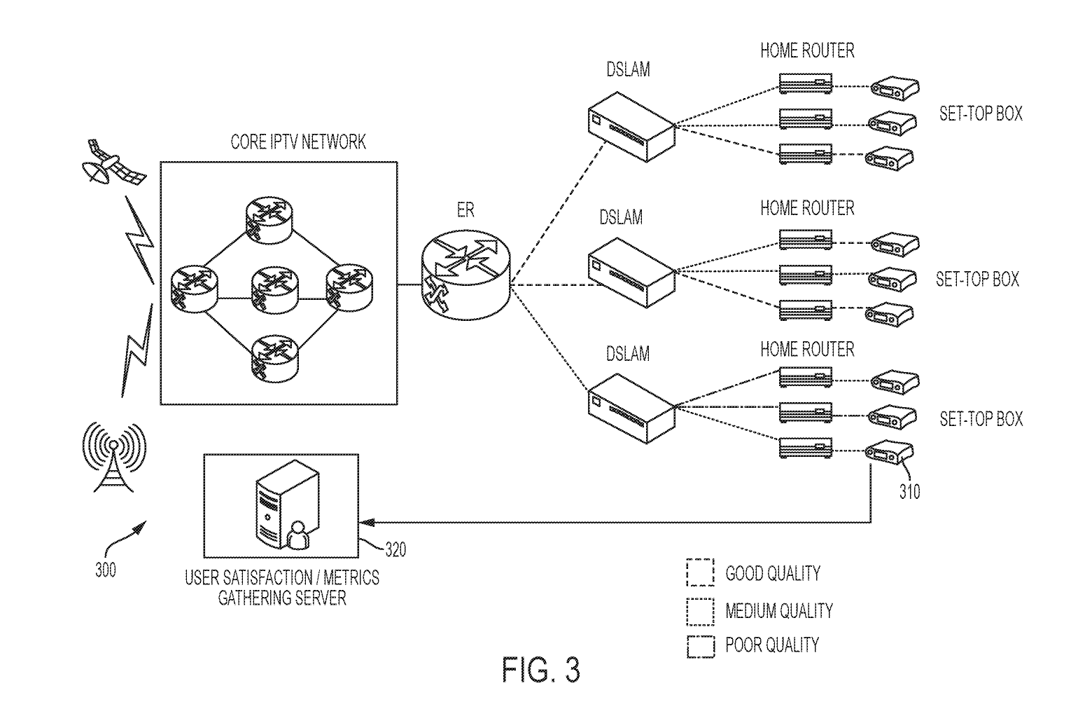

FIG. 3 illustrates an internet protocol television system 300 that receives feedback information from one or more end users, in accordance with one or more embodiments. As described above, with one or more embodiments, the end users can provide feedback to the service provider regarding the broadcast. For example, an end user can send feedback via the end user's set-top box 310. The feedback can then be stored in a gathering server 320 that is generally positioned on the service-provider side.

Based on the feedback that is received by the service provider (from the end user), the service provider can refine the broadcast quality to either improve or to deteriorate. For example, if the service provider determines that a large proportion of the population is watching a football game broadcast, then the service provider can allocate more resources to this football game broadcast. As such, one or more embodiments can predict/determine broadcast quality issues in real-time based on actual network conditions of the internet protocol television system and/or feedback that is based on the actual perception by the end users. Further, one or more embodiments can dynamically allocate resources in accordance to the real-time predictions/determinations. Resources from other broadcasts can be redirected towards the broadcasting of the football game in order to ensure that the football game is broadcasted smoothly. Further, resources can be allocated for different broadcasts in accordance with geography. For example, if the service provider expects that end users of a first geographical area will watch the football game, while end users of a second geographical area will not watch the football game, one or more embodiments can redirect resources from the second geographical area to the first geographical area in order to broadcast the football game.

One or more embodiments can analyze the metrics relating to broadcast quality, the user ratings, and background demographic data. As such, the service provider can adjust resources based on the above. Additionally, the broadcast quality metrics and received user feedback can be saved on a server so that, when similar temporal network measurements are observed, the measurements of broadcast quality can be inferred/predicted based on the previously-stored information.

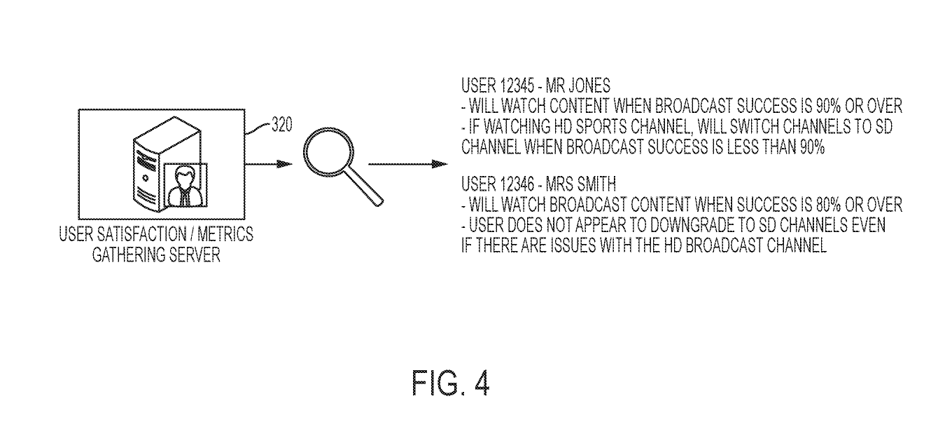

FIG. 4 illustrates determining profile information for a plurality of end users in accordance with one or more embodiments. By referencing information that is stored within gathering server 320, an administrator can determine profile information for one or more end users. For example, based on information that is stored within gathering server 320, one or more embodiments can derive that “User 12345—Mr. Jones” will tend to watch content when the broadcast success/quality is over 90% (i.e., the likelihood of a successful broadcast is 90%). Other embodiments can reference other measurements/metrics with respect to their end users. Further, “User 12345—Mr. Jones,” if watching an HD sports channel, will tend to switch from a high-definition channel to a standard definition channel when the broadcast success/quality is less than 90%. One or more embodiments can allocate resources based on profile information that is gathered about each end user.

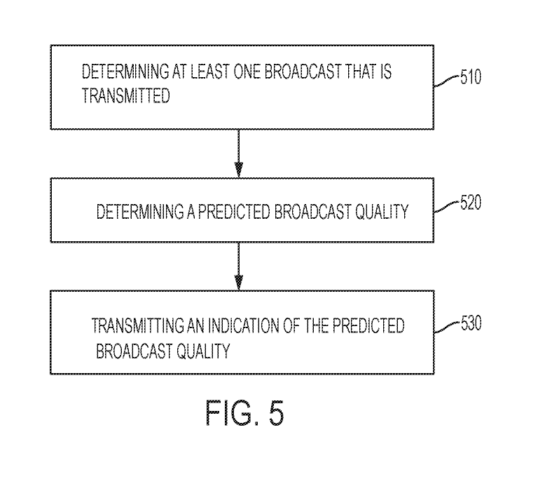

FIG. 5 depicts a flowchart of a method in accordance with one or more embodiments. The method can be performed by a controller of an internet protocol distributing system, for example. The controller can be configured on the service-provider side. For example, the controller can be configured within gathering server 320, a digital subscriber line access multiplexer, router, and/or within any device of the IPTV network. The method includes, at block 510, determining, by the controller of a content provider, at least one broadcast that is transmitted to at least one end user. The method also includes, at block 520, determining a predicted broadcast quality of the at least one broadcast. The method also includes, at block 530, transmitting an indication of the predicted broadcast quality to the at least one end user.

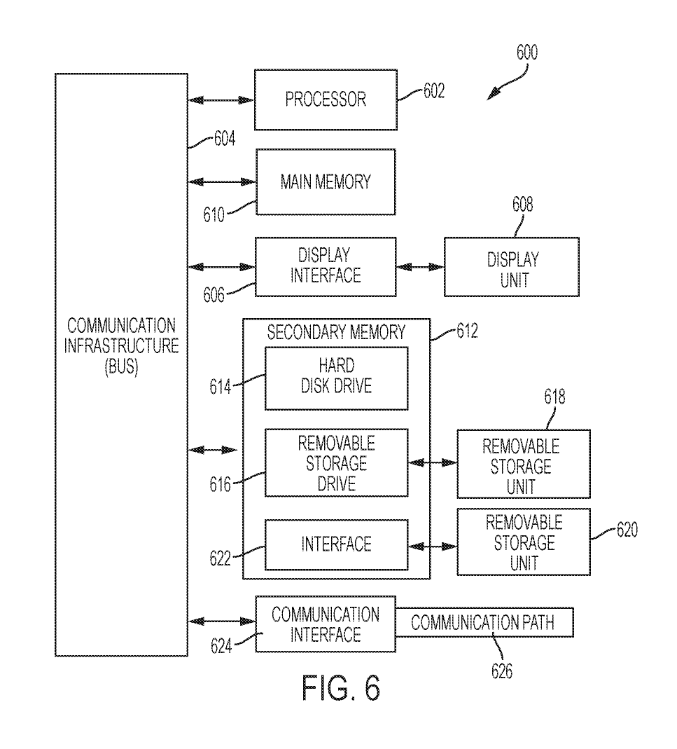

FIG. 6 depicts a high-level block diagram of a computer system 600, which can be used to implement one or more embodiments. Computer system 600 can correspond to, at least, a controller of an IPTV system, for example. Computer system 600 can be used to implement hardware components of systems capable of performing methods described herein. Although one exemplary computer system 600 is shown, computer system 600 includes a communication path 626, which connects computer system 600 to additional systems (not depicted) and can include one or more wide area networks (WANs) and/or local area networks (LANs) such as the Internet, intranet(s), and/or wireless communication network(s). Computer system 600 and additional system are in communication via communication path 626, e.g., to communicate data between them.

Computer system 600 includes one or more processors, such as processor 602. Processor 602 is connected to a communication infrastructure 604 (e.g., a communications bus, cross-over bar, or network). Computer system 600 can include a display interface 606 that forwards graphics, textual content, and other data from communication infrastructure 604 (or from a frame buffer not shown) for display on a display unit 608. Computer system 600 also includes a main memory 610, preferably random access memory (RAM), and can also include a secondary memory 612. Secondary memory 612 can include, for example, a hard disk drive 614 and/or a removable storage drive 616, representing, for example, a floppy disk drive, a magnetic tape drive, or an optical disc drive. Hard disk drive 614 can be in the form of a solid state drive (SSD), a traditional magnetic disk drive, or a hybrid of the two. There also can be more than one hard disk drive 614 contained within secondary memory 612. Removable storage drive 616 reads from and/or writes to a removable storage unit 618 in a manner well known to those having ordinary skill in the art. Removable storage unit 618 represents, for example, a floppy disk, a compact disc, a magnetic tape, or an optical disc, etc. which is read by and written to by removable storage drive 616. As will be appreciated, removable storage unit 618 includes a computer-readable medium having stored therein computer software and/or data.

In alternative embodiments, secondary memory 612 can include other similar means for allowing computer programs or other instructions to be loaded into the computer system. Such means can include, for example, a removable storage unit 620 and an interface 622. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 620 and interfaces 622 which allow software and data to be transferred from the removable storage unit 620 to computer system 600.

Computer system 600 can also include a communications interface 624. Communications interface 624 allows software and data to be transferred between the computer system and external devices. Examples of communications interface 624 can include a modem, a network interface (such as an Ethernet card), a communications port, or a PC card slot and card, a universal serial bus port (USB), and the like. Software and data transferred via communications interface 624 are in the form of signals that can be, for example, electronic, electromagnetic, optical, or other signals capable of being received by communications interface 624. These signals are provided to communications interface 624 via communication path (i.e., channel) 626. Communication path 626 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 610 and secondary memory 612, removable storage drive 616, and a hard disk installed in hard disk drive 614. Computer programs (also called computer control logic) are stored in main memory 610 and/or secondary memory 612. Computer programs also can be received via communications interface 624. Such computer programs, when run, enable the computer system to perform the features discussed herein. In particular, the computer programs, when run, enable processor 602 to perform the features of the computer system. Accordingly, such computer programs represent controllers of the computer system. Thus it can be seen from the foregoing detailed description that one or more embodiments provide technical benefits and advantages.

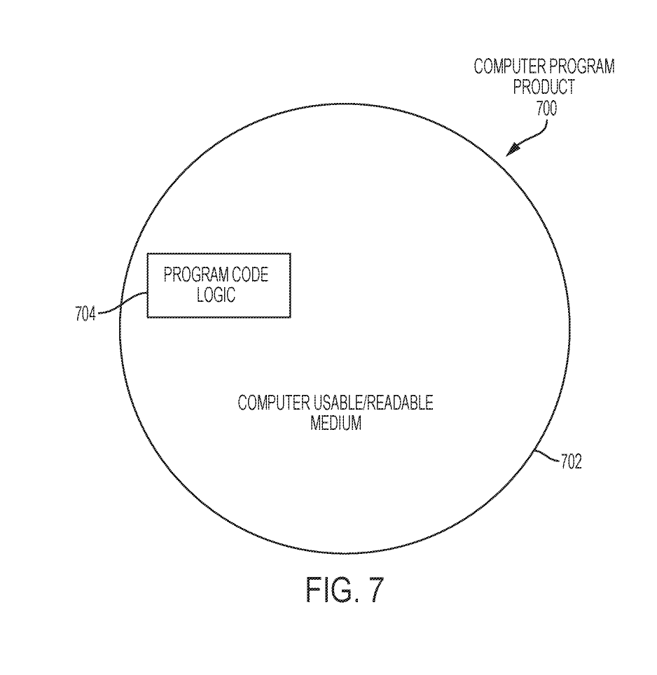

FIG. 7 depicts a computer program product 700, in accordance with an embodiment. Computer program product 700 includes a computer-readable storage medium 702 and program instructions 704.

Embodiments can be a system, a method, and/or a computer program product. The computer program product can include a computer-readable storage medium (or media) having computer-readable program instructions thereon for causing a processor to carry out aspects of one or more embodiments.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform one or more embodiments.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments described. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments described herein.

1. A computer-implemented method, the method comprising:
determining, by a controller of a content provider, at least one broadcast that is transmitted to at least one end user;
determining a predicted broadcast quality of the at least one broadcast; and
transmitting an indication of the predicted broadcast quality to the at least one end user, wherein the indication includes a likelihood that the at least one broadcast will be transmitted without interruption.

2. The computer-implemented method of claim 1, wherein the controller comprises a controller of an internet protocol television system.

3. The computer-implemented method of claim 1, wherein the determining the predicted broadcast quality comprises determining a quality-of-experience measurement of the at least one broadcast.

4. The computer-implemented method of claim 1, wherein the determining the predicted broadcast quality comprises determining quality-of-experience measurements on a per channel/broadcast basis.

5. The computer-implemented method of claim 1, wherein the transmitting the indication of the predicted broadcast quality to the at least one end user comprises displaying a visual overlay in an electronic program guide.

6. The computer-implemented method of claim 1, further comprising receiving a feedback regarding the at least one broadcast from the end user.

7. The computer-implemented method of claim 6, further comprising refining a broadcast quality of the at least one broadcast based on the feedback.

8. A computer system comprising:
a memory; and
a processor system communicatively coupled to the memory, the processor system configured to perform a method comprising:
determining at least one broadcast that is transmitted to at least one end user;
determining a predicted broadcast quality of the at least one broadcast; and
transmitting an indication of the predicted broadcast quality to the at least one end user, wherein the indication includes a likelihood that the at least one broadcast will be transmitted without interruption.

9. The computer system of claim 8, wherein the computer system comprises a computer system of an internet protocol television system.

10. The computer system of claim 8, wherein the determining the predicted broadcast quality comprises determining a quality-of-experience measurement of the at least one broadcast.

11. The computer system of claim 8, wherein the determining the predicted broadcast quality comprises determining quality-of-experience measurements on a per channel/broadcast basis.

12. The computer system of claim 8, wherein the transmitting the indication of the predicted broadcast quality to the at least one end user comprises displaying a visual overlay in an electronic program guide.

13. The computer system of claim 8, wherein the processor system is further configured to receive a feedback regarding the at least one broadcast from the end user.

14. The computer system of claim 13, wherein the processor system is further configured to refine a broadcast quality of the at least one broadcast based on the feedback.

15. A computer program product comprising:
a computer-readable storage medium having program instructions embodied therewith, wherein the computer-readable storage medium is not a transitory signal per se, the program instructions readable by a processor system to cause the processor system to perform a method comprising:
determining, by a controller of a content provider, at least one broadcast that is transmitted to at least one end user;
determining a predicted broadcast quality of the at least one broadcast; and
transmitting an indication of the predicted broadcast quality to the at least one end user, wherein the indication includes a likelihood that the at least one broadcast will be transmitted without interruption.

16. The computer program product of claim 15, wherein the controller comprises a controller of an internet protocol television system.

17. The computer program product of claim 15, wherein the determining the predicted broadcast quality comprises determining a quality-of-experience measurement of the at least one broadcast.

18. The computer program product of claim 15, wherein the determining the predicted broadcast quality comprises determining quality-of-experience measurements on a per channel/broadcast basis.

19. The computer program product of claim 15, wherein the transmitting the indication of the predicted broadcast quality to the at least one end user comprises displaying a visual overlay in an electronic program guide.

20. The computer program product of claim 15, wherein the method further comprises receiving a feedback regarding the at least one broadcast from the end user.
